(19) United States
(12) Patent Application Publication
(10) Pub. No.: US 2008/0229862 A1
(43) Pub. Date: Sep. 25, 2008

(54) WIRE DRIVE MECHANISM, ROBOT ARM MECHANISM, AND ROBOT

(75) Inventor: Hideichi Nakamoto, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/048,391

(22) Filed: Mar. 14, 2008

(30) Foreign Application Priority Data
Mar. 22, 2007 (JP) 2007-075502

(51) Int. Cl. B25J 18/00

(52) U.S. Cl. 74/490.04; 901/21

(57) ABSTRACT

A wire driving mechanism is provided with a pulley rotated around a rotation axis, a pulley which is disposed on the same plane as the rotation axis in a direction perpendicular to the rotation axis and rotated around a rotation axis, and a wire wound around on the peripheral surface of the pulley in a predetermined direction, and at the same time, wound around on the peripheral surface of the pulley in the opposite direction to the winding direction on the pulley. Thus, a drive force is transmitted from the pulley to the pulley through the wire.

### CROSS-REFERENCE TO RELATED APPLICATIONS

This application is based upon and claims the benefit of priority from prior Japanese Patent Application No. 2007-075502, filed Mar. 22, 2007, the entire contents of which are incorporated herein by reference.

### BACKGROUND OF THE INVENTION

1. Field of the Invention

The present invention relates to a wire driving mechanism which transmits power through a wire, and a robot arm mechanism and a robot to which the wire driving mechanism is applied.

2. Description of the Related Art

The recent development of robot technology is remarkable, and various kinds of service robots with arms which move close to humans and perform auxiliary operations for humans to support human's life have been developed. Such a robot which moves close to humans and performs auxiliary operations has frequent contact with humans, and thus the robot is required to have a function for not harming humans even when the robot contacts with the humans. As a method for ensuring safety, it is considered that the weight of the robot arm is reduced as much as possible to reduce the impact in case of a collision with a human.

In many cases, the conventional robot arms adopt a structure in which a joint part of the arm is driven by an actuator disposed in the joint part. However, a large payload must be treated in order to perform the effective operations with the robot arm, and thus a large actuator is required to be used in the robot arm. However, such a large actuator leads to a vicious circle in which a further large actuator should be used in the joint part on the root side of the robot arm for the purpose of supporting the weight of the actuator itself.

Therefore, conventionally, there are wire driving mechanisms in which the actuator is disposed not in the joint part, but on a robot body side, and the power is transmitted from the robot body side to the joint part through a wire or the like. According to such a wire driving mechanism, the arm can be manufactured as light as possible, whereby the safety can be ensured even if the arm collides with a human.

Meanwhile, the robot arm is provided with the combination of a plurality of joint parts of which rotation axes are directed to various directions. If this robot arm is constituted of a wire driving mechanism, it is necessary to provide a change mechanism for changing the rotating direction of the wire transmission. JP-A. H11-254376 (KOKAI) discloses a wire driving mechanism using a wire. In this wire driving mechanism, a wire guide is disposed between a wire pulley fixed to an output shaft and a movable part provided around an axis perpendicular to the output shaft. A wire is provided through the wire guide, and the wire transmits tension force to the movable part through the wire guide with the rotation of the wire pulley, thereby rotating the movable part around the axis perpendicular to the output shaft.

In the wire driving mechanism disclosed in JP-A H11-254376 (KOKAI), the wire transmission direction is changed by using the wire guide as a relay pulley. However, the use of this type of relay pulley renders the drive mechanism larger so that the arm becomes larger in size and heavier in the structure in which the mechanism should be compactly disposed in the arm, especially the robot arm. In addition, the transmission through the relay pulley makes the wire length longer to thereby cause degradation of transmission efficiency.

Meanwhile, although it may be considered that a bevel gear is used as the change mechanism for changing the rotational direction in the wire transmission, there is a problem that the use of the bevel gear makes the joint part heavier.

### BRIEF SUMMARY OF THE INVENTION

According to one aspect of the present invention, there is provided a wire driving mechanism, comprising:

first and second pulleys which have first and second rotation axes and first and second peripheral surfaces, respectively, the first and second pulleys being arranged that tips of the first and second peripheral surfaces are closely located and the first and second rotation axes being crossed each other; and

a wire wound around the first peripheral surface in a first predetermined winding direction, and wound around the second peripheral surface in the opposite winding direction to the first predetermined winding direction.

According to another aspect of the present invention, there is provided a wire driving mechanism, comprising:

first and second pulleys which have first and second rotation axes and first and second peripheral surfaces, respectively, the first and second pulleys being arranged that tips of the first and second peripheral surfaces are closely located and the first and second rotation axes being crossed each other;

a first wire wound around one of the first peripheral surfaces in a first predetermined winding direction, and wound around one of the second peripheral surfaces in the opposite winding direction to the first predetermined winding direction; and

a second wire wound around another one of the second peripheral surfaces in the first predetermined winding direction, and wound around another one of the first peripheral surfaces in the opposite winding direction to the first predetermined winding direction.

According to yet another aspect of the present invention, there is provided a robot arm mechanism, comprising:

first and second pulleys which have first and second rotation axes and first and second peripheral surfaces, respectively, the first and second pulleys being arranged that tips of the first and second peripheral surfaces are closely located and the first and second rotation axes being crossed each other;

a third pulley which is coaxially mounted on the first pulley;

a first link rotatably provided with the third pulley;

a second link rotatably supported by the first link, and rotatable with the second pulley;

a first wire wound around one of the first peripheral surfaces in a first predetermined winding direction, and wound around one of the second peripheral surfaces in the opposite winding direction to the first predetermined winding direction;

a second wire wound around another one of the second peripheral surfaces in the first predetermined winding direction, and wound around another one of the first peripheral surfaces in the opposite winding direction to the first predetermined winding direction;

a third wire wound around the third pulley;

a first actuator which drives the first and second wires; and

a second actuator which drives the third wire.

### BRIEF DESCRIPTION OF THE SEVERAL VIEWS OF THE DRAWING

FIG. 1 is a side view schematically showing a basic structure of a wire driving mechanism according to a first embodiment of the invention;

FIG. 2 is a side view schematically showing a basic structure of a wire driving mechanism according to a second embodiment of the invention;

FIG. 3 is a side view schematically showing a basic structure of a wire driving mechanism according to a first modified example 1 of the wire driving mechanism shown in FIG. 2;

FIG. 4 is a side view schematically showing a basic structure of a wire driving mechanism according to a second modified example 2 of the wire driving mechanism shown in FIG. 2;

FIG. 5 is a side view schematically showing a basic structure of a wire driving mechanism according to a third embodiment of the invention;

FIG. 6 is a plan view schematically showing a basic structure of a wire pulley drive mechanism shown in FIG. 5;

FIG. 7 is a schematic view showing a schematic structure of a wire tension adjustment mechanism shown in FIG. 5;

FIG. 8 is a side view schematically showing a mechanism for preventing a rapid speed change in a joint part used in the third embodiment of the invention;

FIG. 9 is a plan view schematically showing a mechanism which detects wire tension to apply braking and is used in the third embodiment of the invention;

FIG. 10A is a side view showing a schematic constitution in a fourth embodiment of the invention;

FIG. 10B is a block diagram of a control system in the fourth embodiment of the invention;

FIG. 11A is a side view showing a schematic constitution in a fifth embodiment of the invention;

FIG. 11B is a block diagram of a control system in the fifth embodiment of the invention;

FIG. 12A is a plan view showing a schematic constitution in a sixth embodiment of the invention;

FIG. 12B is a side view showing the schematic constitution in the sixth embodiment of the invention;

FIG. 13 is a side view schematically showing a schematic constitution in a seventh embodiment of the invention; and

FIG. 14 is a side view schematically showing a schematic constitution in an eighth embodiment of the invention.

### DETAILED DESCRIPTION OF THE INVENTION

Hereinafter, a wire driving mechanism, a robot arm mechanism, and a robot according to embodiments of the invention will be described with reference to the drawings.

### First Embodiment

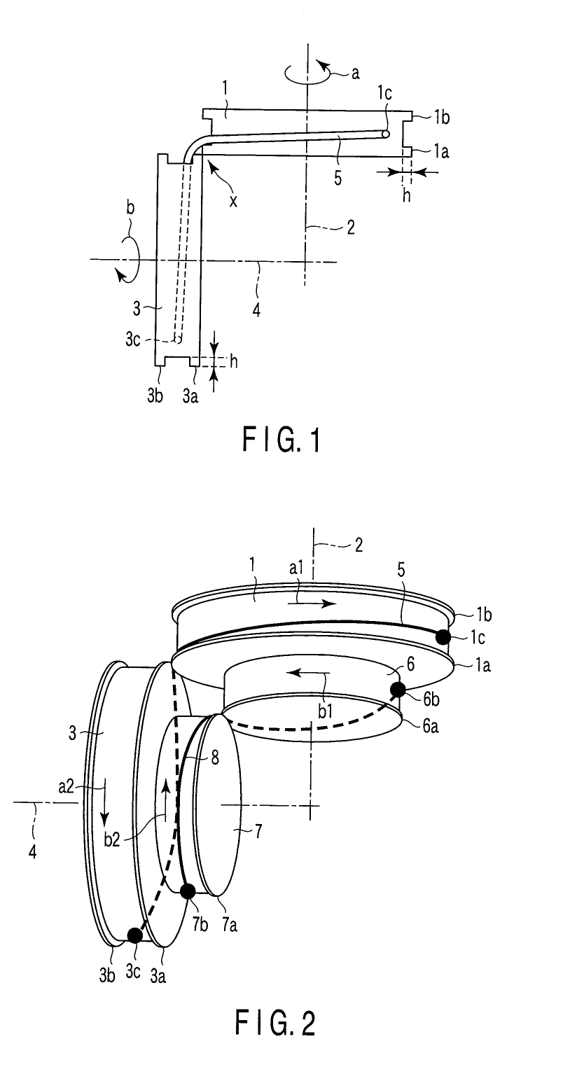

FIG. 1 shows a wire driving mechanism according to a first embodiment of the invention. In FIG. 1, reference numeral 1 represents a pulley. The pulley 1 is so supported as to be rotatable around a rotation axis 2. The circumference of the pulley 1 has flange parts 1a and 1b with a height of h integrally formed along both peripheral edges of the pulley 1.

Another pulley 3 is provided to correspond to the pulley 1. The pulley 3 is so supported as to be rotatable around a rotation axis 4. The pulley 3 is arranged that the tip of the pulley 3 is closely located to the tip of the pulley 1. The rotation axis 4 crosses the rotation axis 2 at a predetermined angle. In the example in FIG. 1, the rotation axis 4 is disposed on the same plane as the rotation axis 2 in the perpendicular direction. Therefore, a pair of the pulleys 1 and 3 is disposed so that their rotation planes are crossed, for instance, they are perpendicular to each other. The pulley 3 has flange parts 3a and 3b with a height of h as wire falling-out prevention means integrally formed along both peripheral edges of the pulley 3. The flange part 3a corresponding to one peripheral edge of the pulley 3 is disposed to approach the flange part 1a, which is one peripheral edge of the pulley 1, at an interval of x not more than a diameter of a wire 5 to be described later.

In the pair of pulleys 1 and 3, one end of the wire 5 is fixed to a wire fixed point 1c on the peripheral surface of the pulley 1, and wound around the peripheral surface of the pulley 1 along a rotational direction a. Meanwhile, the wire 5 is wound around the peripheral surface of the pulley 3 in the opposite winding direction (the same direction as a rotational direction b) to the winding direction on the pulley 1 (the same direction as the rotational direction a). Namely, the wire 5 is extended from one space (reference plane) in the upper part of FIG. 1 toward another space (reference plane) in the lower part of FIG. 1 so that the wire 5 is extended from the pulley 1 to the pulley 3. Another end of the extended wire 5 is fixed to a wire fixed point 3c on the peripheral surface of the pulley 3 to connect the pair of pulleys 1 and 3 through the wire 5. With regard to the disposition of the pulleys 1 and 3, and the wire 5 shown in FIG. 1, the wire 5 is wound without falling out from the peripheral surfaces of the pulleys 1 and 3 owing to the flange parts 1a and 3a disposed to approach with each other at the interval x. In addition, the wire 5 has a diameter which is larger than the interval between the pulley 1 and the pulley 3.

In the disposition of the pulleys 1 and 3 connected through the wire 5, for instance, when the pulley 1 is rotated in a direction of an arrow a in FIG. 1, the tension force is applied to the wire 5 due to the rotational movement of the wire fixed point 1c, and thus the tension force acts on the wire fixed point 3c on the pulley 3 through the wire 5, whereby the pulley 3 is rotated in a direction of an arrow b in FIG. 1. Namely, in addition to the rotation of the pulley 1, the drive force is transmitted to the pulley 3 through the wire 5, so that it becomes possible to rotate the pulley 3 around an axis perpendicular to the rotation axis 2 of the pulley 1.

According to the above wire driving mechanism, the rotational direction is transmitted through the wire 5, and thus it is possible to change the rotational direction from the direction a of the axis 2 to the direction b of the axis 4. In addition, the above constitution can realize the weight and size reduction of a wire driving mechanism with fewer components than the conventional mechanism using a relay pulley or a bevel gear.

In the above embodiment, although the rotation axes 4 and 2 are disposed to be on the same plane in the perpendicular direction, the rotation axes 4 and 2 may not cross perpendicularly to each other, and besides may not be disposed on the same plane.

In addition, the pulleys 1 and 3 may be constituted to have a two-step pulley part, for example. In the wire driving mechanism in which the pulleys 1 and 3 have the two-step pulley part, a first wire 5 is stretched between a first-step pulley of the pulley 1 and a first-step pulley of the pulley 3, while a second wire 5 is stretched between a second-step pulley of the pulley 1 and a second-step pulley of the pulley 3. The pair of wires 5 is wound around the pulley parts of the pulleys 1 and 3 corresponding similarly to the pulleys in FIG. 1, whereby the two wires 5 can realize larger power transmission.

### Second Embodiment

Although only the power in one direction can be transmitted in the first embodiment, a second embodiment can realize the transmission of a wire drive force to both rotational directions by using two wires. Namely, in the wire driving mechanism shown in FIG. 1, when the rotation axis 2 is a main axis, the rotation axis 4 becomes a driven axis rotating with the rotation of the axis 2, whereby the pulley 3 is rotated in the rotational direction b with the rotation of the pulley 1 in the rotational direction a. However, even if the pulley 1 is rotated in the opposite direction to the rotational direction a, the pulley 3 is not rotated in the opposite direction to the rotational direction b. According to a wire driving mechanism shown in FIG. 2, even if the pulley 1 is rotated in either one of forward and backward directions, the pulley 3 can also be rotated in either one of the forward and backward directions.

FIG. 2 shows a wire driving mechanism according to the second embodiment of the invention. In FIG. 2, the same components as those in FIG. 1 are represented by the same numbers, and thus the detailed description thereof is omitted.

In the wire driving mechanism shown in FIG. 2, a small pulley 6 with a small diameter is integrally provided in the pulley 1 to be coaxial with the pulley 1, and thus the pulley 1 is constituted as a so-called two-step pulley. The pulley 6 has a flange part 6a integrally formed along the peripheral edge at the opposite side end to the pulley 1 side. In a similar manner, a small pulley 7 with a small diameter is integrally provided in the pulley 3 to be coaxial with the pulley 3, and thus the pulley 3 is constituted as a so-called two-step pulley. The pulley 7 has a flange part 7a integrally formed along the peripheral edge at the opposite side end to the pulley 3 side.

As in the first embodiment, the wire 5 is wound around between the pulleys 1 and 3. Meanwhile, in the pulleys 6 and 7, one end of a wire 8 is fixed to a wire fixed point 6b on the peripheral surface of the pulley 6. The wire 8 is wound around the peripheral surface of the pulley 6 in the opposite direction to the winding direction of the wire 5 onto the pulley 1. The wire 8 is further wound around the peripheral surface of the pulley 7 in the opposite direction to the winding direction on the pulley 6 and besides in the opposite direction to the winding direction of the wire 5 onto the pulley 3. Another end of the wire 8 is fixed to a wire fixed point 7a on the peripheral surface of the pulley 7 to connect the pulleys 6 and 7 by the wire 8. As with the case of the first embodiment, the wire 8 is wound without falling out from the peripheral surfaces of the pulleys 6 and 7 owing to the flange parts 6a and 7a.

In the above constitution in FIG. 2, when the pulley 1 is rotated in a direction of an arrow a1, the wire fixed point 1c is moved to transmit the tension force of the wire 5 to the wire fixed point 3c of the pulley 3, whereby the pulley 3 is rotated in a direction of an arrow a2. Meanwhile, when the pulley 6 is rotated in a direction of an arrow b1 which is opposite to the direction a1, the wire fixed point 6b is moved to transmit the tension force of the wire 8 to the wire fixed point 7b of the pulley 7, whereby the pulley 7 is rotated in a direction of an arrow b2.

In the above wire driving mechanism, the wire drive force can be transmitted in both rotational directions by using the two wires 5 and 8. Namely, when the pulley 1 is rotated in the rotational directional, the rotation drive force is transmitted through the wire 5 to rotate the pulley 3 in the rotational direction a2 as with the wire driving mechanism in FIG. 1. Meanwhile, when the pulley 1 is rotated in the rotational direction b1, the rotation drive force is transmitted through the wire 5 based on the drive transmission principle as with the case in FIG. 1, and thus the pulley 3 is rotated in the rotational direction b2. Accordingly, in the second embodiment, in addition to the similar effect described in the first embodiment, even when the main pulleys 1 and 6 are rotated in either rotational direction, the driven pulleys 3 and 7 can be rotated and driven in the corresponding rotational direction.

In the above embodiment, the pulleys 1 and 6, and the pulleys 3 and 7 are separately provided; however, they may be an integrated two-step pulley.

### Modified Example 1

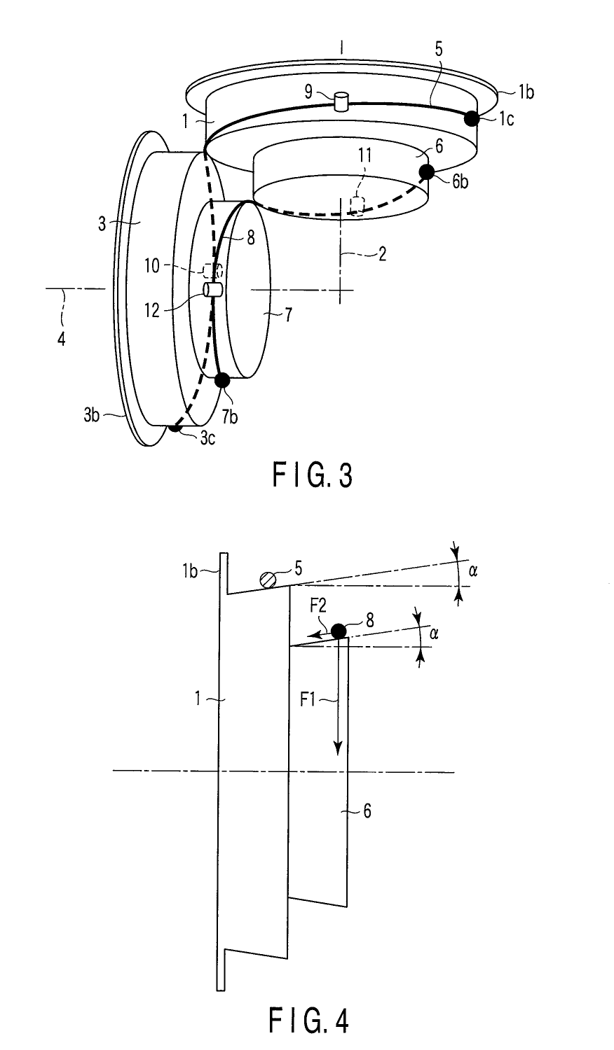

FIG. 3 shows a wire driving mechanism according to a modified example 1 of the second embodiment shown in FIG. 2. In the description referring to FIG. 3, the same components as those in FIG. 2 are represented by the same numbers, and thus the detailed description thereof is omitted.

The pulleys 1 and 3 shown in FIG. 2 of the second embodiment respectively have the flange parts 1a and 3a integrally formed along one peripheral edges of the pulleys 1 and 3, while the pulleys 6 and 7 have the flange parts 6a and 7a integrally formed along the peripheral edges of the pulleys 6 and 7. However, in FIG. 3, the pulleys 1 and 3 have pins 9 and 10, which are the wire falling-out prevention means, on the peripheral surfaces, instead of the flange parts 1a and 3a, while the pulleys 6 and 7 have pins 11 and 12 on the peripheral surfaces, instead of the flange parts 6a and 7a. The pins 9 and 10 are used for guiding the movement of the wire 5 to prevent the wire 5 from falling out from the peripheral surfaces of the pulleys 1 and 3. Likewise, the pins 11 and 12 are used for guiding the movement of the wire 8 to prevent the wire 8 from falling out from the peripheral surfaces of the pulleys 6 and 7.

According to such a wire driving mechanism, the pins 9 and 10 are provided on the peripheral surfaces of the pulleys 1 and 3, and the pins 11 and 12 are provided on the peripheral surfaces of the pulleys 6 and 7, whereby it is possible to surely prevent the loosened wire 5 or 8 from falling out from the peripheral surfaces of the pulleys 1 and 3, or the pulleys 6 and 7.

The power transmission efficiency of the pins 9 and 10 is lowered as the respective positions are further moved to the region where the pulleys 1 and 3 approach with each other with the rotation thereof, and if the pulleys 1 and 3 are further rotated, the power is not transmitted. Thus, the pins 9 and 10 are required to be disposed so as not to be positioned in the region where the pulleys 1 and 3 approach with each other in the rotation range of the pulleys 1 and 3. The same holds for the pins 11 and 12 provided in the pulleys 6 and 7.

### Modified Example 2

FIG. 4 shows a wire driving mechanism according to a modified example 2 of the second embodiment. In the wire driving mechanism shown in FIG. 4, the pulley 1 having the integrally provided pulley 6 with a small diameter in the second embodiment is provided with the flange part 1b integrally formed along the peripheral edge at the opposite side to the pulley 6, and the diameter of the pulley 1 gradually increases from the end part on the flange part 1b side toward the other end part. Namely, the diameter of the pulley 1 becomes gradually larger from the end part on the flange part 1b side toward the other end part (in the direction of the rotation axis 2) to form its peripheral surface into an inclined surface at a taper angle α, and thus to constitute the wire falling-out prevention means. Likewise, the diameter of the pulley 6 becomes gradually larger from the end part on the pulley 1 side toward the other end part (in the direction of the rotation axis 2) to form its peripheral surface into an inclined surface at a taper angle α.

In the above constitution, the pulleys 1 and 6 respectively have tapers α formed on the peripheral surfaces around which the wires 5 and 8 are wound. For instance, when the tension is applied to the wire 8, a force F1 in the vertical direction is applied to the pulley 6; however, due to the taper α, the force F1 is decomposed into the normal force of the peripheral surface of the pulley 6 and a force F2 perpendicular to the normal force. The force F2 is applied, whereby the force in the direction of the pulley 1 side is applied to the wire 8, so that it is possible to surely prevent the wire 8 from falling out from the peripheral surface of the pulley 6.

In this embodiment, although the relation between the pulley 6 and the wire 8 has been described, the same holds for the relation between the pulley 1 and the wire 5. In addition, needless to say, the same holds for the above-mentioned pulley 3 having the pulley 7 with a small diameter on the same axis as the pulley 3.

### Third Embodiment

Next, a robot arm mechanism provided with a wire driving mechanism according to a third embodiment of the invention will be described.

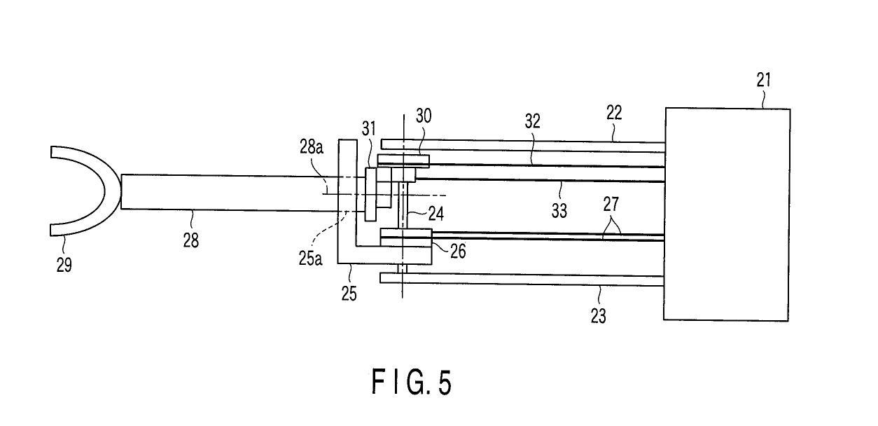

FIG. 5 schematically shows a robot arm mechanism to which the above-mentioned wire driving mechanism is applied. In FIG. 5, reference numeral 21 represents a pedestal part 21. In the pedestal part 21, a pair of main links 22 and 23 with a predetermined length is protruded and extended from the pedestal part 21 to be parallel to each other. A rotation axis 24 is provided between the front ends of the main links 22 and 23.

A first link 25 is rotatably provided in the rotation axis 24. The first link 25 is formed into an L-like shape, and the base end thereof is rotatably supported around the rotation axis 24. The front end (extended part having a free end) of the first link 25 bent at a right angle is extended and disposed in the direction perpendicular to the main links 22 and 23, and the front end is rotated in the front-back direction in the drawing due to the rotation of the base end around the rotation axis 24.

A pulley 26 is integrally provided in the base end of the first link 25. The pulley 26 is rotatably supported around the rotation axis 24 of the first link 25. The power from the pedestal part 21 is transmitted to the pulley 26 through a wire 27 wound around the pulley 26, and thus the pulley 26 is rotated around the rotation axis 24 of the first link 25.

In the first link 25, a bearing 25a is provided in the front end (extended part) bent at a right angle, and a second link 28 is rotatably supported by the bearing 25a. The second link 28 is perpendicular to the rotation axis 24, and provided in a direction in which the pair of main links 22 and 23 is extended. A hand 29 is provided in the front end of the second link 28.

The wire driving mechanism shown in FIG. 2, which is the similar one described in the second embodiment, is disposed between the rotation axis 24 and the second link 28. In this wire driving mechanism, a first two-step pulley 30 corresponding to the above-mentioned pulleys 1 and 6 is rotatably provided in the rotation axis 24, while a second two-step pulley 31 corresponding to the above-mentioned pulleys 3 and 7 is integrally provided in the front end of the second link 28 in the direction perpendicular to the rotation axis 24. In the constitution shown in FIG. 5, the rotation centers of the second two-step pulley 31 and the second link 28 coincide with each other, and thus the second link 28 is rotated with the rotation of the second two-step pulley 31. Meanwhile, two wires 32 and 33 corresponding to the above-mentioned wires 5 and 8 are wound around between the first two-step pulley 30 and the second two-step pulley 31, and at the same time, the power transmission from the pedestal part 21 can be realized by using the wires 32 and 33, thereby making it possible to rotate the second link 28 in the both directions around a rotation center 28a.

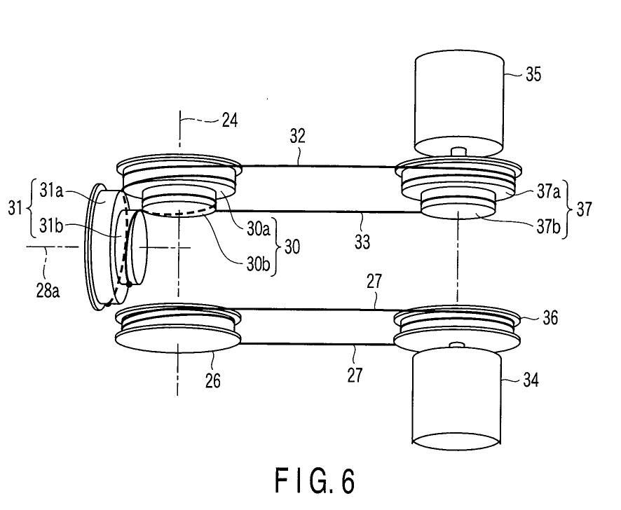

FIG. 6 shows a wire pulley drive mechanism shown in FIG. 5. The same components as those in FIG. 5 are represented by the same numbers. In the wire pulley drive mechanism shown in FIG. 5, actuators 34 and 35 having a motor are provided in the pedestal part 21. A pulley 36 is attached to a rotation axis of the actuator 34, while a two-step pulley 37 is attached to a rotation axis of the actuator 35.

The wire 27 wound around the pulley 26 is also wound around the pulley 36. The power is transmitted to the pulley 26 through the wire 27 by the rotation of the pulley 36 by the actuator 34 to thereby rotate the first link 25 around the rotation axis 24 with the rotation of the pulley 26.

Meanwhile, the two wires 32 and 33 wound around between the first two-step pulley 30 and the second two-step pulley 31 are also wound around the two-step pulley 37. The power is transmitted to the first two-step pulley 30 and the second two-step pulley 31 through the wires 32 and 33 by the rotation of the two-step pulley 37 by the actuator 35. In this wire pulley drive mechanism, as described in the second embodiment, the one end of the wire 32 is fixed onto the peripheral surface of a large-diameter pulley 31a of the second two-step pulley 31. The wire 32 is wound around the large-diameter pulley 31a of the two-step pulley 31 and a large-diameter pulley 30a of the first two-step pulley 30 in the winding direction which has been described by referring to FIG. 2. The wire 32 is guided to the actuator 35 side, and thus is further wound around a large-diameter pulley 37a of the two-step pulley 37, and at the same time, the one end is fixed onto the peripheral surface of the large-diameter pulley 37a. Likewise, the one end of the wire 33 is fixed onto a peripheral surface of a small-diameter pulley 31b of the second two-step pulley 31, and at the same time, is wound around the small-diameter pulley 31b of the second two-step pulley 31 and a small-diameter pulley 30b of the first two-step pulley 30 in the above-mentioned winding direction. The wire 33 is guided to the actuator 35 side to be wound around a small-diameter pulley 37b of the two-step pulley 37, and at the same time, the one end is fixed onto the peripheral surface of the small-diameter pulley 37b. If the radius ratio between the large-diameter pulley 37a and the small-diameter pulley 37b of the two-step pulley 37 and that between the large-diameter pulley 30a and the small-diameter pulley 30b of the two-step pulley 30 are rendered the same, it is possible to prevent the rotation rate of the two-step pulley 30 from changing due to the rotation of the actuator 35, whereby easy rotation control can be realized.

In such a wire pulley drive mechanism, when the pulley 36 is rotated by the actuator 34, the power is transmitted to the pulley 36 through the wire 27, thereby making it possible to rotate the first link 25 around the rotation axis 24 with the rotation of the pulley 26. Thereby, the bending of an elbow joint of the robot arm can be realized.

Meanwhile, when the two-step pulley 37 is rotated by the actuator 35, the power is transmitted to the first and second two-step pulleys 30 and 31 through the wires 32 and 33. Thereby, the first two-step pulley 30 can be rotated around the rotation axis 24, and at the same time, the second two-step pulley 31 can be rotated around the rotation center 28a of the second link 28. In this case, when the rotational direction of the actuator 35 is switched, the rotational direction of the second two-step pulley 31 can be selected in accordance with the rotational direction of the first two-step pulley 30 corresponding to the switched rotational direction. Thereby, it is possible to realize the rotational movement of the elbow joint of the robot arm due to the second link 28 rotating with the second two-step pulley 31.

Therefore, according to the above constitution, the actuators 34 and 35 can be disposed in the pedestal part 21 on the robot body side without being disposed in the joint part of the arm, and at the same time, the joint part to which the rotation axis is perpendicular can be constituted by using the wire driving mechanism, whereby it is possible to realize a robot arm mechanism with the weight and size reduced and with high transmission efficiency.

### Modified Example 1

In the above-mentioned robot arm mechanism, the wire tension in a wire drive system is loosened, whereby the wire may fall out from the pulley. As a measure thereof, it is considered to prevent the loosening of the wire tension by adjusting a path length of the wire.

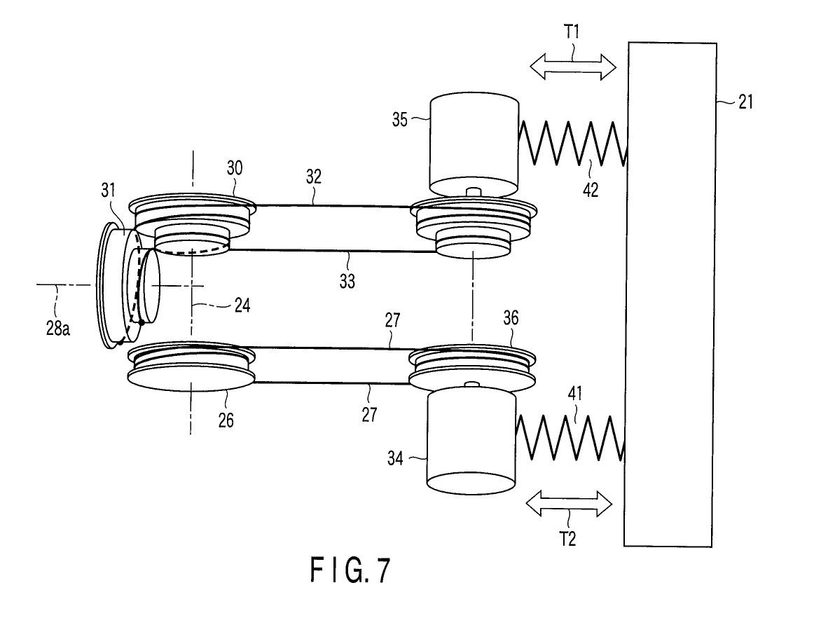

FIG. 7 shows a wire tension adjustment mechanism. In FIG. 7, the same components as those in FIG. 6 are represented by the same numbers, and thus the description thereof is omitted.

In this wire pulley drive mechanism, a tension adjustment mechanism 41 is disposed between the pedestal part 21 and the actuator 34, while a tension adjustment mechanism 42 is disposed between the pedestal part 21 and the actuator 35. The tension adjustment mechanisms 41 and 42 are constituted of a spring or an actuator, and have a function for moving the entire actuators 34 and 35 to a position corresponding to the wire tension in the directions of arrows T1 and T2.

For instance, when the tension of the wire 27 between the pulleys 36 and 26 is loosened to decrease the wire tension, the entire actuator 34 is moved in the direction of the pedestal part 21 by the tension adjustment mechanism 41, and thus the wire path length is longer, whereby the tension of the wire 27 can be increased. Needless to say, also when the tension of the wires 32 and 33 between the two-steps pulleys 37 and 30 is loosened to decrease the wire tension, the wire tension is adjusted by the tension adjustment mechanism 42 in a similar manner.

Accordingly, according to the above constitution, the wire tension can be always adjusted in a proper condition, so that it is possible to surely prevent the wire from falling out from the pulley due to the loosening of the wire tension.

In this type of wire drive system, the wire is prevented from falling out from the pulley, and at the same time, it is necessary to prevent the robot arm from being out of control even if the wire is detached from the pulley. Namely, when the wire is detached or cut, the link is held in a freely rotatable state. Consequently, the link gets out of control to cause danger if the large force is applied to the link.

As a measure thereof, it is considered to prevent the rapid speed change in the joint part or to prevent the rapid tension change in the wire.

### Modified Example 2

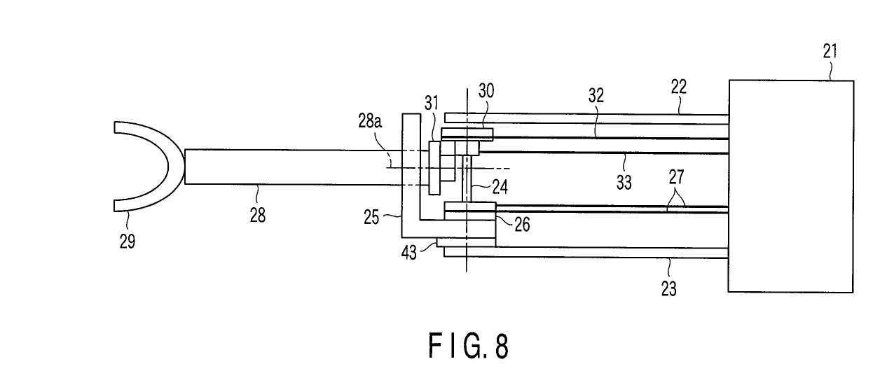

FIG. 8 shows a mechanism for preventing the rapid speed change in the joint part. In FIG. 8, the same components as those in FIG. 5 are represented by the same numbers, and thus the description thereof is omitted. In the mechanism shown in FIG. 8, the main link 23 constituting the joint part and the first link 25 are connected to each other through a centrifugal clutch 43, which is a mechanism for controlling the rotation rate. Although the centrifugal clutch 43 is free at a rate not more than a certain rotation rate without transmitting the power, it transmits the power at a rate not less than a certain rotation rate. The centrifugal clutch 43 is well-known, and thus need not to be described.

In the above mechanism, the rapid rotation rate is generated in the first link 25, and thus the centrifugal clutch 43 is operated to change into a state that the power is transmitted to the main link 23. Thereby, the same effect as braking is applied to the first link 25 so as to prevent the rapid rotation rate change, whereby it is possible to prevent the wire from falling out from the pulley, and at the same time, to prevent the first link 25 from being out of control even if the wire is detached.

### Modified Example 3

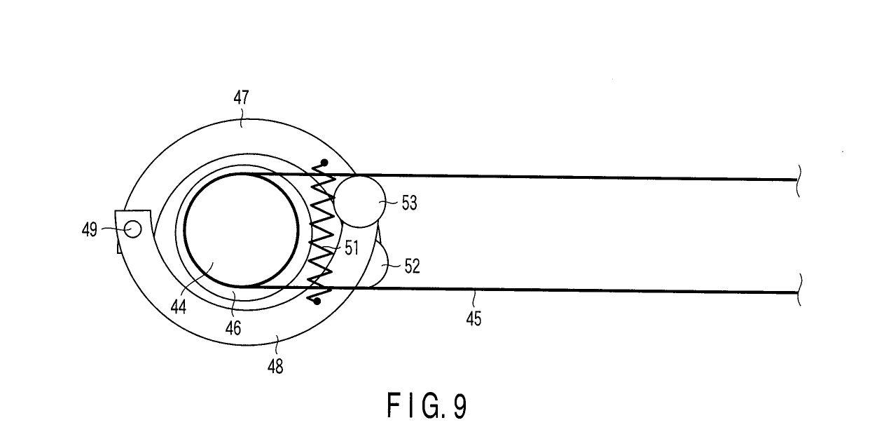

FIG. 9 shows a mechanism for preventing the rapid tension change in the wire, that is, a mechanism for detecting the wire tension to apply braking.

In this mechanism, a wire 45 is wound around a pulley 44, and the power is transmitted through the wire 45. A brake drum 46 is fixed to the pulley 44. Brake shoes 47 and 48 are disposed along a periphery of the brake drum 46. One ends of the brake shoes 47 and 48 are rotatably supported by the rotation axis 49, and thus the brake drum 46 can be pressed from two directions in response to the rotation of each brake shoe to the pulley 44 side. Meanwhile, a spring 51 is disposed between the ends of the brake shoes 47 and 48 on the opposite side of the rotation axis 49. In response to the tension force of the spring 51, the brake shoes 47 and 48 are in a state that the pressing force from the two directions is applied to the brake drum 46 to apply braking to the pulley 44. There are pulleys 52 and 53 respectively provided in the front ends of the brake shoes 47 and 48 on the opposite side of the rotational axis 49. These pulleys 52 and 53 are in contact with the wire 45, and rotate the brake shoes 47 and 48 in a direction against the tension force of the spring 51 due to the tension of the wire 45. Thereby, if the tension of the wire 45 reaches a certain level or more, the brake shoes 47 and 48 are separated from the brake drum 46 due to the rotation of the brake shoes 47 and 48 against the tension force of the spring 51 to release the braking state.

Therefore, according to this mechanism, while the tension of the wire 45 above a certain level is applied, the brake shoes 47 and 48 are separated from the brake drum 46 to be free from braking. When the tension of the wire 45 is loosened, the brake shoes 46 and 47 come in contact with the brake drum 46 due to the tension force of the spring 51, and thus braking is applied. Thereby, it is possible to realize the constitution capable of preventing the wire 45 from falling out from the pulley 44, and at the same time, capable of safely stopping the link even in the detachment of the wire 45.

### Fourth Embodiment

Next, a robot arm mechanism according to a fourth embodiment of the invention and a speed controller will be described.

The fourth embodiment shows a speed controller for the robot arm mechanism described in the third embodiment.

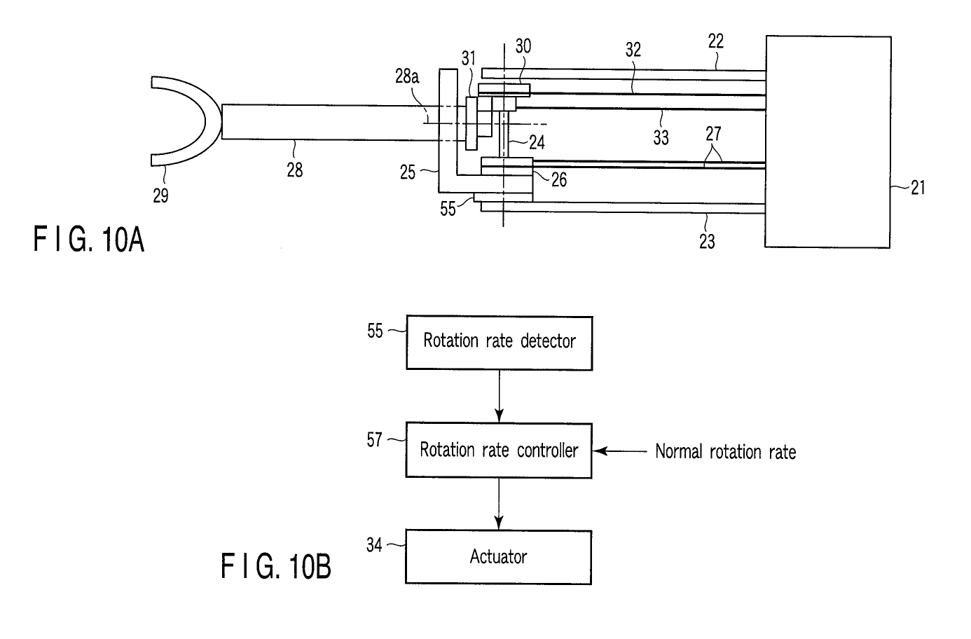

FIG. 10A shows a robot arm mechanism. In FIG. 10A, the same components as those in FIGS. 5 and 6 are represented by the same numbers, and thus the description thereof is omitted. In the robot arm mechanism, for instance, a rotation rate detector 55 is disposed between the main link 23 and the first link 25. The rotation rate detector 55 detects the rotation rate of the first link 25 with respect to the main link 23.

FIG. 10B shows a schematic constitution of a rotation rate controller for controlling the rotation rate of the robot arm mechanism. In this rotation rate controller, the actuator 34 described in FIG. 6 is constituted of a motor.

The actuator (motor) 34 shown in FIG. 10B transmits the power to the pulley 26 through the wire 27 shown in FIG. 10A to rotate the first link 25 around the rotation axis 24. A rotation rate controller 57 is connected to the actuator 34, while the above-mentioned rotation rate detector 55 is connected to the rotation rate controller 57. A normal rotation rate of the actuator 34 is given beforehand to the rotation rate controller 57. The rotation rate controller 57 compares the normal rotation rate with the rotation rate of the first link 25 detected in the rotation rate detector 55, and controls the rotation rate of the actuator 34 in accordance with the comparison result. Namely, a rotation rate signal depending on the rotation rate of the first link 25 detected in the rotation rate detector 55 and a comparison signal corresponding to the normal rotation rate are compared with each other, and thus the rotation rate of the actuator 34 is determined by the rotation rate controller 57 on the basis of the comparison result (difference between signals). Thus, the rotation rate controller 57 lowers the rotation rate of the first link 25 by controlling the actuator 34 if the rotation rate of the first link 25 is higher than the normal rotation rate, while raises the rotation rate of the first link 25 by controlling the actuator 34 if the rotation rate of the first link 25 is lower than the normal rotation rate.

Therefore, according to the above embodiment, the rotation rate of the first link 25 can be controlled so as to be the normal rotation rate by the actuator 34 controlled by the rotation rate controller 57, whereby it is possible to prevent the rapid change in the rotation rate of the first link 25 constituting the joint part of the robot arm mechanism, so that it is possible to surely prevent the wire 27 from falling out from the pulley 26.

### Fifth Embodiment

Next, a robot arm mechanism according to a fifth embodiment of the invention and a wire tension controller will be described.

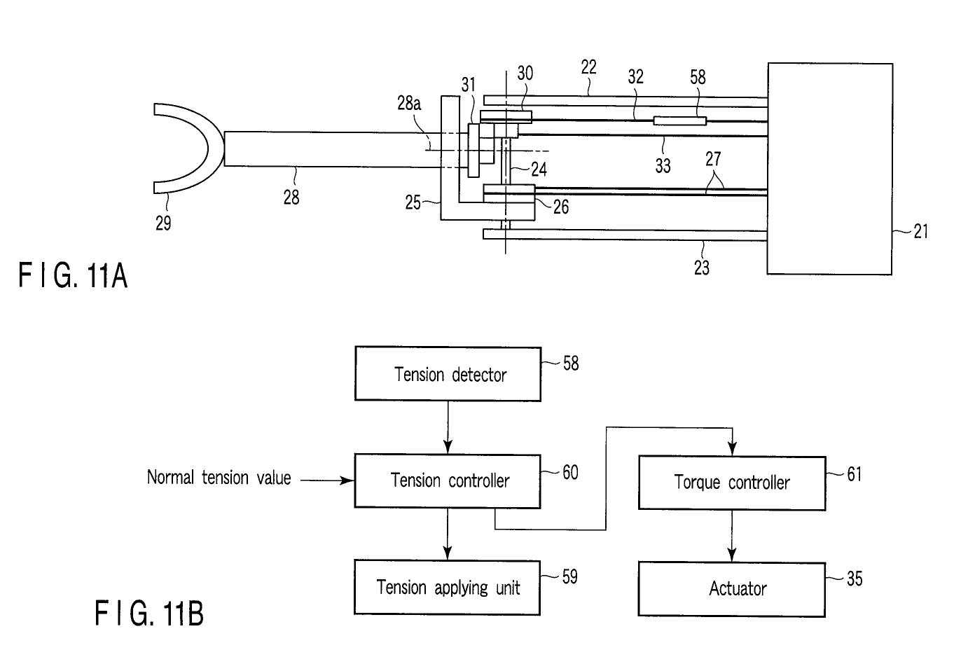

FIGS. 11A and 11B show a wire tension controller for the robot arm mechanism according to the fifth embodiment. FIG. 11A shows the robot arm mechanism described in the third embodiment, and thus the same components as those in FIGS. 5 and 6 are represented by the same numbers, whereby the description thereof is omitted. In this robot arm mechanism, for instance, a tension detector 58 is provided at an intermediate part of the wire 32. The tension detector 58 detects the tension of the wire 32.

FIG. 11B shows a schematic constitution of a tension controller for controlling the tension of the wire (wire 32) of a wire drive system. In the tension controller, the actuator 35 described in FIG. 6 corresponds to a motor.

In the tension controller shown in FIG. 11B, reference numeral 59 is a tension applying unit. The tension applying unit 59 is constituted of the tension adjustment mechanism 42, which has been described in FIG. 7, and is disposed between the actuator 35 and the pedestal part 21.

A tension controller 60 is connected to the tension applying unit 59, while the above-mentioned tension detector 58 is connected to the tension controller 60. A normal tension value is given to the tension controller 60. The tension controller 60 compares the normal tension value with the tension of the wire 32 detected in the tension detector 58, and adjusts the tension in the tension applying unit 59 in response to the comparison result. Namely, the tension controller 60 controls the tension applying unit 59 so as to increase the wire tension if the detected wire tension (tension signal) detected in the tension detector 58 becomes rapidly smaller, while controls the tension applying unit 59 so as to decrease the wire tension if the detected wire tension (tension signal) becomes rapidly larger.

Meanwhile, a torque controller 61 is connected to the tension controller 60, while the actuator (motor) 35 is connected to the torque controller 61. The torque controller 61 controls the torque output from the actuator 35 in response to the output of the tension controller 60. Namely, when the tension controller 60 generates the output for adjusting the wire tension to the tension applying unit 59, the actuator 35 accordingly controls the torque to be output.

Accordingly, the above constitution can realize that the tension of the wire 32 is automatically adjusted on the basis of the tension detector 58 for detecting the tension of the wire 32, whereby it is possible to prevent wire loosening and to surely prevent the wire from falling out from the pulley.

In this embodiment, only the wire 32 shown in FIG. 11A has been described; however, this embodiment can also be applied to the wires 33 and 27.

### Sixth Embodiment

Next, a multi-jointed robot arm mechanism according to a sixth embodiment of the invention will be described.

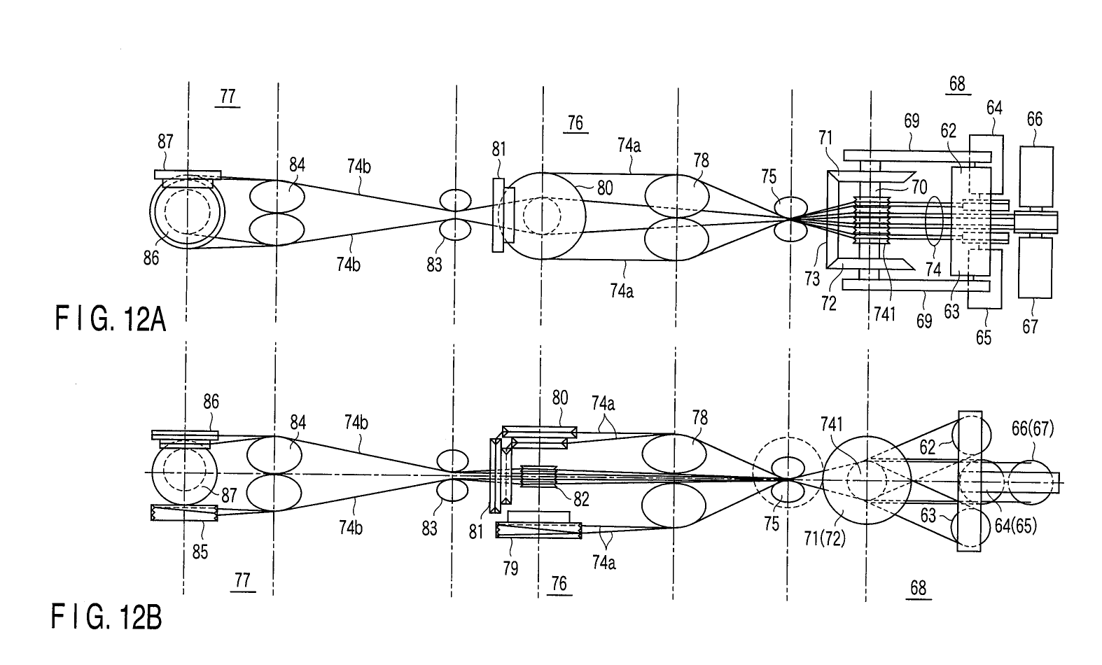

FIGS. 12A and 12B show a multi-jointed robot arm mechanism constituted by providing a plurality of the above-mentioned robot arm mechanisms.

In this mechanism, arms have six degrees of freedom, and have six motors 62 to 67 as actuators for driving these arms. The motors 62 to 67 are disposed in the pedestal part 21 (not shown in FIGS. 12A and 12B).

A shoulder part 68 is driven by the motors 62 and 63. In this shoulder part 68, a pair of frames 69 is supported by a pedestal part (not shown), and rotators 71 and 72 are rotatably supported by a rotation shaft 70 in the front end of the frame 69. A rotator 73 rotating with the rotation of the rotators 71 and 72 is provided. The rotators 71 and 72 are driven by the motors 62 and 63, and thus it is possible to rotate the rotators 71 and 72 around the rotation shaft 70. The rotator 73 can be rotated around the axis perpendicular to the rotation shaft 70 in accordance with the rotation of the rotators 71 and 72. Namely, the two degrees of freedom movement can be realized by the rotation of the rotators 71, 72 and 73.

A free pulley 741 is provided in the rotation shaft 70. A wire group 74 having eight wires driven by the motors 64 to 67 is routed through the free pulley 741 and transported toward an elbow part 76 and a wrist part 77 through a throttle mechanism 75. In this constitution, the throttle mechanism 75 presses the wire group 74 led from the shoulder part 68 into the narrow path. The wire group 74 is routed through the throttle mechanism 75, whereby the wire drive force can be transmitted to the elbow part 76 and the wrist part 77 even if there are the two degrees of freedom movement in the shoulder part 68. Especially, in the throttle mechanism 75, the wire group 74 is passed as close as possible to the rotation center, whereby it is possible to prevent the wire path length from being substantially changed by the rotation in the shoulder part 68.

In the wire group 74 having eight wires, a wire group 74a having four wires driven by the motors 64 and 65 is led from the throttle mechanism 75 through an expansion pulley 78, and thus the power is transmitted to the elbow part 76. As in the case described in FIG. 6, pulleys 79, 80 and 81 (corresponding to the pulleys 26, 30 and 31 in FIG. 5) are provided in the elbow part 76, and this constitution can realize the bending of the elbow part 76 by the pulley 79 and realize the two degrees of freedom movement in the rotation of the elbow part 76 by the pulleys 80 and 81. In this constitution, the power of the wire is transmitted through the throttle mechanism 75 and the expansion pulley 78, whereby it is possible to prevent the wire group 74a from falling out from the pulleys 79, 80 and 81 even if the two-degree of freedom of the elbow part 76 is rotated.

In the wire group 74 having eight wires, a wire group 74b having four wires driven by the motors 66 and 67 is led from the throttle mechanism 75 through a free pulley 82 of the elbow part 76, a throttle mechanism 83 and an expansion pulley 84, and thus the power is transmitted to the wrist part 77. Pulleys 85, 86 and 87 (corresponding to the pulleys 26, 30 and 31 in FIG. 5) are provided in the wrist part 77, and this constitution can realize the bending of the wrist part 77 by the pulley 85 and the two degrees of freedom movement in the rotation of the wrist part 77 by the pulleys 86 and 87. Also in this case, the power of the wire is transmitted through the throttle mechanism 83 and the expansion pulley 84, whereby it is possible to prevent the wire group 74b from falling out from the pulleys 85, 86 and 87 even if the two-degree of freedom of the wrist part 77 is rotated.

Therefore, the above constitution can realize the disposition of each join part including the shoulder part 68, the elbow part 76 and the wrist part 77 which are similar to the arms of a human and can realize multi-jointed movement constituted by these joint parts. In addition, since each of the motors 62 to 67 in the actuator is not provided in the joint part, but is brought together on the pedestal part, the reduction of the weight and size can be realized.

### Seventh Embodiment

Next, a wire pulley transmission mechanism according to a seventh embodiment of the invention will be described.

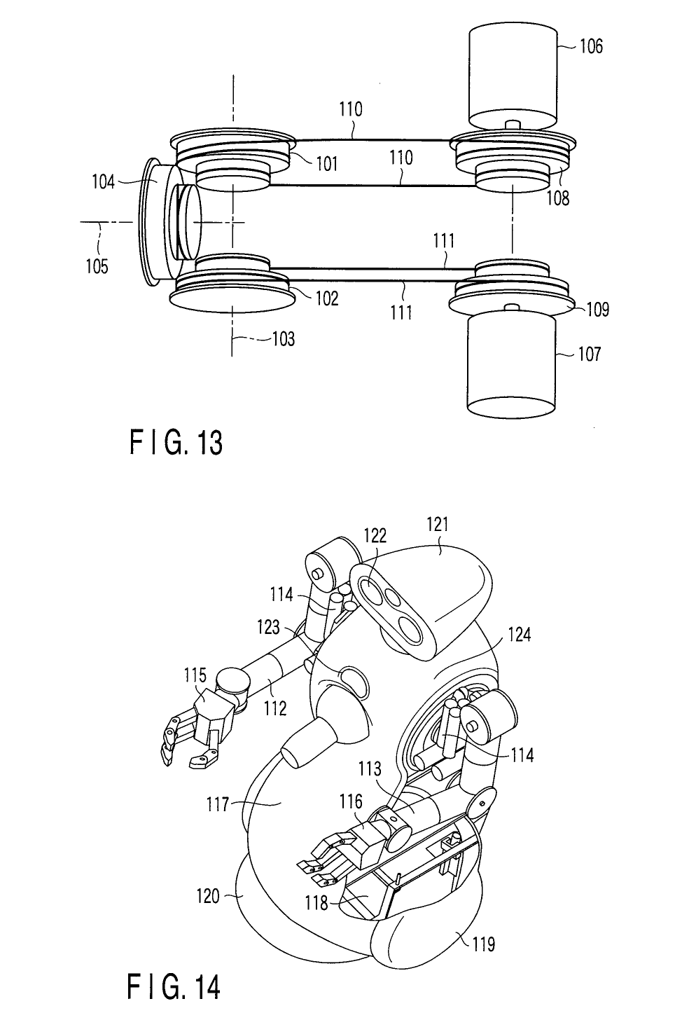

FIG. 13 shows another example of the wire pulley transmission mechanism.

In FIG. 13, reference numerals 101 and 102 represent two-step pulleys. The two-step pulleys 101 and 102 are rotatably supported by the same rotation axis 103. Another two-step pulley 104 is disposed while corresponding to the two-step pulleys 101 and 102. The pulley 104 is rotatably supported by a rotation axis 105 on the same plane as the rotation axis 103 of the two-step pulleys 101 and 102 in a direction perpendicular to the rotation axis 103.

Meanwhile, in FIG. 13, actuators 106 and 107 are disposed on the side of a pedestal part (not shown). Two-step pulleys 108 and 109 are respectively attached to the rotation axis of the actuators 106 and 107. The power is transmitted from the actuator 106 to the two-step pulley 104 through the two-step pulley 101 by a wire 110 wound around the two-step pulley 108, while the power is transmitted from the actuator 107 to the two-step pulley 104 through the two-step pulley 102 by a wire 111 wound around the two-step pulley 109. In this wire pulley transmission mechanism, the winding direction of the wire 110 to the two-step pulleys 101 and 104 and the winding direction of the wire 111 to the two-step pulleys 102 and 104 are similar to the winding direction described in FIG. 6.

The above constitution can realize that the two degrees of freedom rotation of the bending and rotation of the elbow part can be interference driven by the actuators 106 and 107. Namely, the outputs of the actuators 106 and 107 are controlled to be coordinated, whereby the outputs can be efficiently divided into two degrees of freedom by the actuators 106 and 107, for instance, the degree of freedom requiring the torque in the two degrees of freedom is moved by the actuators 106 and 107.

### Eighth Embodiment

Next, a robot, to which a multi-jointed robot arm mechanism is applied, according to an eighth embodiment of the invention will be described.

FIG. 14 shows a schematic constitution of a robot to which the multi-jointed robot arm mechanism described in the sixth embodiment is applied.

In FIG. 14, reference numerals 112 and 113 are arms to which the multi-jointed robot arm mechanism described in FIG. 12 is applied, and drive all joint parts by a motor (not shown) disposed in a motor part 114. In this case, the entire arms 112 and 113 are rotated in each of the motor parts 114, and besides, one degree of freedom is further added, whereby a seven-degree freedom arm which is the same as the human's arm can be realized. In addition, hands 115 and 116 are provided in the end of the arms 112 and 113 to allow the operation such as gripping an object with the hands 115 and 116.

On the other hand, a controller 118 for controlling the entire robot is built in a robot body 117, as well as the arms 112 and 113. The robot body 117 can be freely moved by a movement mechanism 119. The movement mechanism 119 is constituted of a right and left independent drive wheel. The right and left independent drive wheel is controlled, and thereby a robot can be moved to a target position posture. Meanwhile, a sensor 120 is attached to a lower position of the robot body 117 so as to detect obstacles therearound. The upper part of the robot body 117 has a head part 121. The head part 121 is connected to the robot body 117 through a drive mechanism for changing the direction. In addition, a visual part 122 is mounted in the head part 121, whereby the position and posture of an object to be operated by the arms can be detected by image processing with a camera, for example. Further, a speaker 123 and a microphone 124 are provided in the robot, whereby it is possible to communicate with a human.

According to the above-mentioned embodiments of the invention, the invention can provide a wire driving mechanism, a robot arm mechanism and a robot which can realize the reduction of the weight and size.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wire driving mechanism, comprising:
first and second pulleys which have first and second rotation axes and first and second peripheral surfaces, respectively, the first and second pulleys being arranged that tips of the first and second peripheral surfaces are closely located and the first and second rotation axes being crossed each other; and
a wire wound around the first peripheral surface in a first predetermined winding direction, and wound around the second peripheral surface in the opposite winding direction to the first predetermined winding direction.

2. The wire driving mechanism according to claim 1, wherein an interval between the first and the second pulleys is smaller than a diameter of the wire.

3. The wire driving mechanism according to claim 1, wherein the first and second pulleys have wire falling-out prevention part configured to prevent the wire from being detached from the first and second pulleys.

4. A wire driving mechanism, comprising:
first and second pulleys which have first and second rotation axes and first and second peripheral surfaces, respectively, the first and second pulleys being arranged that tips of the first and second peripheral surfaces are closely located and the first and second rotation axes being crossed each other;
a first wire wound around one of the first peripheral surfaces in a first predetermined winding direction, and wound around one of the second peripheral surfaces in the opposite winding direction to the first predetermined winding direction; and
a second wire wound around another one of the second peripheral surfaces in the first predetermined winding direction, and wound around another one of the first peripheral surfaces in the opposite winding direction to the first predetermined winding direction.

5. The wire driving mechanism according to claim 4, wherein the first and second pulleys have wire falling-out prevention part configured to prevent the wire from being detached from the first and second pulleys.

6. The wire driving mechanism according to claim 4, wherein an interval between the first and the second pulleys is smaller than a diameter of the wire.

7. A robot arm mechanism, comprising:
first and second pulleys which have first and second rotation axes and first and second peripheral surfaces, respectively, the first and second pulleys being arranged that tips of the first and second peripheral surfaces are closely located and the first and second rotation axes being crossed each other;
a third pulley which is coaxially mounted on the first pulley;
a first link rotatably provided with the third pulley;
a second link rotatably supported by the first link, and rotatable with the second pulley;
a first wire wound around one of the first peripheral surfaces in a first predetermined winding direction, and wound around one of the second peripheral surfaces in the opposite winding direction to the first predetermined winding direction;
a second wire wound around another one of the second peripheral surfaces in the first predetermined winding direction, and wound around another one of the first peripheral surfaces in the opposite winding direction to the first predetermined winding direction;
a third wire wound around the third pulley;
a first actuator which drives the first and second wires; and
a second actuator which drives the third wire.

8. The robot arm mechanism according to claim 7, wherein one of the first to third wires is provided with a tension adjustment mechanism which vary a wire path length to adjust a wire tension.

9. The robot arm mechanism according to claim 7, wherein at least one of the first, second and third pulleys has a braking mechanism which limits rotation when a tension of the one of the wires is smaller than a predetermined level.

10. A robot which is provided with the robot arm mechanism according to claim 7.
